(19) United States
(12) Patent Application Publication
(10) Pub. No.: US 2024/0058926 A1
(43) Pub. Date: Feb. 22, 2024

(54) SCREWDRIVER

(71) Applicant: MAKITA CORPORATION, Anjo-shi (JP)

(72) Inventor: Ryuki YUEDA, Anjo-shi (JP)

(73) Assignee: MAKITA CORPORATION, Anjo-shi (JP)

(21) Appl. No.: 18/220,492

(22) Filed: Jul. 11, 2023

(30) Foreign Application Priority Data
Aug. 18, 2022 (JP) 2022-130471

(51) Int. Cl. B25B 21/00; B25F 5/00; B25F 5/02

(52) U.S. Cl. CPC B25B 21/00; B25F 5/001; B25F 5/008; B25F 5/02

(57) ABSTRACT

A screwdriver is less likely to have an increased overall length. A screwdriver includes a motor, a push-in clutch located frontward from the motor, the push-in clutch being drivable by the motor, a spindle located frontward from the push-in clutch, the spindle being drivable by the push-in clutch, a push-in sensor located radially outward from and below the push-in clutch, the push-in sensor being configured to detect the push-in clutch being pushed in, and a battery configured to power the motor.

### CROSS-REFERENCE TO RELATED APPLICATIONS

This application claims the benefit of priority to Japanese Patent Application No. 2022-130471, filed on Aug. 18, 2022, the entire contents of which are hereby incorporated by reference.

### BACKGROUND

### 1. Technical Field

The present disclosure relates to a screwdriver.

### 2. Description of the Background

In the technical field of screwdrivers, a screwdriver with a push-drive assembly (also referred to as an auto-start assembly) is known, as described in Japanese Unexamined Patent Application Publication No. 2022-012471.

### BRIEF SUMMARY

A screwdriver including a push-drive assembly can have an increased overall length depending on the structure of the push-drive assembly.

The present disclosure is directed to a screwdriver including a push-drive assembly that is less likely to have an increased overall length.

A first aspect of the present disclosure provides a screwdriver, including:
a motor;
a push-in clutch located frontward from the motor, the push-in clutch being drivable by the motor;
a spindle located frontward from the push-in clutch, the spindle being drivable by the push-in clutch;
a push-in sensor located radially outward from and below the push-in clutch, the push-in sensor being configured to detect the push-in clutch being pushed in; and
a battery configured to power the motor.

A second aspect of the present invention provides a screwdriver, including:
a motor;
a push-in clutch located frontward from the motor, the push-in clutch being drivable by the motor;
a spindle located frontward from the push-in clutch, the spindle being drivable by the push-in clutch;
a push-in sensor located radially outward from the push-in clutch, the push-in sensor being configured to detect the push-in clutch being pushed in;
a battery configured to power the motor;
a second bearing supporting the push-in clutch in a rotatable manner; and
a magnet supporting the second bearing in a rotatable manner.

A third aspect of the present invention provides a screwdriver, including:
a motor;
a push-in clutch located frontward from the motor, the push-in clutch being drivable by the motor;
a spindle located frontward from the push-in clutch, the spindle being drivable by the push-in clutch;
a magnet located radially outward from the push-in clutch, the magnet being movable in the front-rear direction in synchronization with the spindle;
a magnetic sensor located radially outward from the spindle, the magnetic sensor being configured to detect the magnet;
a battery configured to power the motor;
a spindle front bearing supporting the spindle in a rotatable manner; and
a front housing supporting the spindle front bearing, the front housing located between the magnet and the magnetic sensor.

The screwdriver including the push-drive assembly according to the above aspects of the present disclosure is less likely to have an increased overall length.

### BRIEF DESCRIPTION OF DRAWINGS

FIG. 1 is a perspective view of a screwdriver according to an embodiment as viewed from the front.

FIG. 2 is a perspective view of the screwdriver according to the embodiment as viewed from the rear.

FIG. 3 is a side view of the screwdriver according to the embodiment.

FIG. 4 is a longitudinal sectional view of the screwdriver according to the embodiment.

FIG. 5 is a partially enlarged longitudinal sectional view of the screwdriver according to the embodiment.

FIG. 6 is a partially enlarged longitudinal sectional view of a main part of the screwdriver according to the embodiment.

FIG. 7 is a partial horizontal sectional view of the screwdriver according to the embodiment.

FIG. 8 is a cross-sectional view of the screwdriver according to the embodiment.

FIG. 9 is a cross-sectional view of the screwdriver according to the embodiment.

FIG. 10 is an exploded perspective view of the main part of the screwdriver according to the embodiment as viewed from the front.

FIG. 11 is an exploded perspective view of the main part of the screwdriver according to the embodiment as viewed from the rear.

FIG. 12 is a longitudinal sectional view of a main part of a screwdriver according to a modification.

FIG. 13 is a longitudinal sectional view of a main part of a screwdriver according to a modification.

### DETAILED DESCRIPTION

One or more embodiments will now be described with reference to the drawings. The components in the embodiments described below may be combined as appropriate. One or more components may be eliminated.

In the embodiments, the positional relationships between the components will be described using the directional terms such as right and left (or lateral), front and rear (or frontward and rearward), and up and down (or vertical). The terms indicate relative positions or directions with respect to the center of a screwdriver 1. The screwdriver 1 according to the embodiments includes a spindle 9 that rotates about a rotation axis CX.

In the embodiments, a direction parallel to the rotation axis CX is referred to as an axial direction or axially for convenience. A direction about the rotation axis CX is referred to as a circumferential direction or circumferentially, or a rotation direction for convenience. A direction radial from the rotation axis CX is referred to as a radial direction or radially for convenience.

A predetermined axial direction away from the center of the screwdriver 1, or a position farther from the center of the screwdriver 1 in the predetermined axial direction, is referred to as a first axial direction for convenience. The direction opposite to the first axial direction is referred to as a second axial direction for convenience. A predetermined circumferential direction is referred to as a first circumferential direction for convenience. The direction opposite to the first circumferential direction is referred to as a second circumferential direction for convenience. A radial direction away from a rotation axis AX, or a position farther from the rotation axis AX in the radial direction, is referred to as radially outward for convenience. The direction opposite to radially outward is referred to as radially inward for convenience.

In the embodiments, the axial direction corresponds to the front-rear direction. The first axial direction may be from the rear to the front. The second axial direction may be from the front to the rear.

### Screwdriver

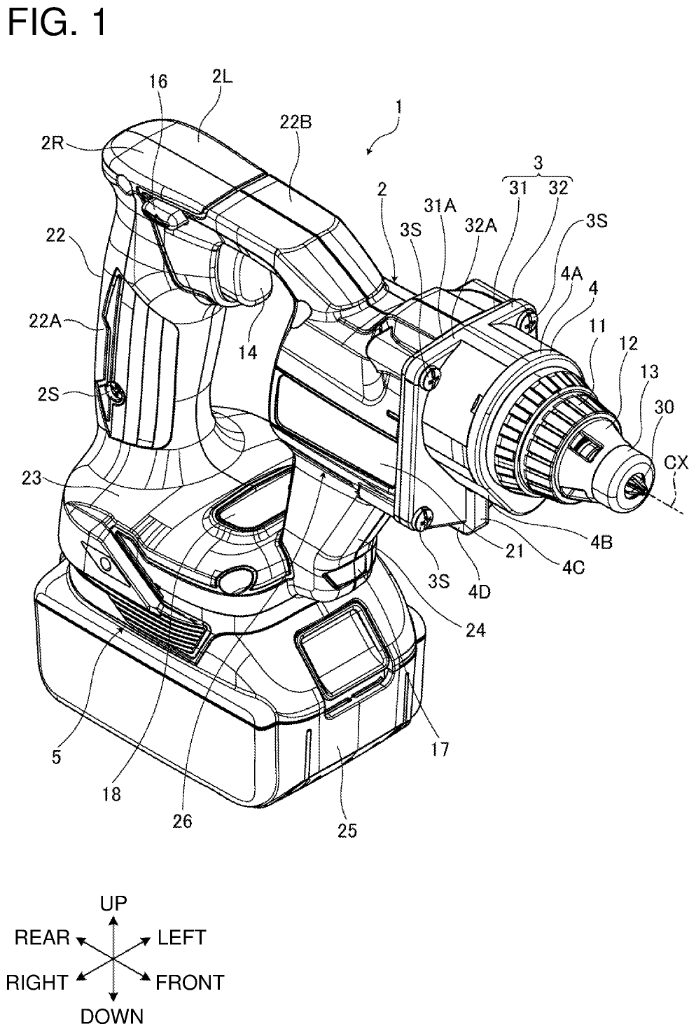

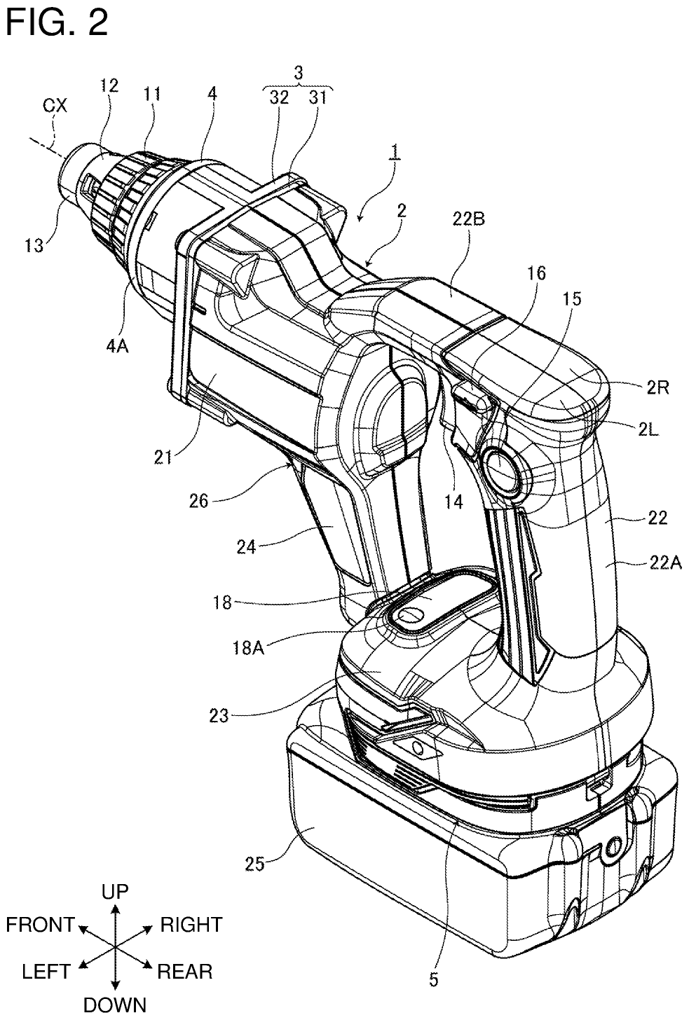

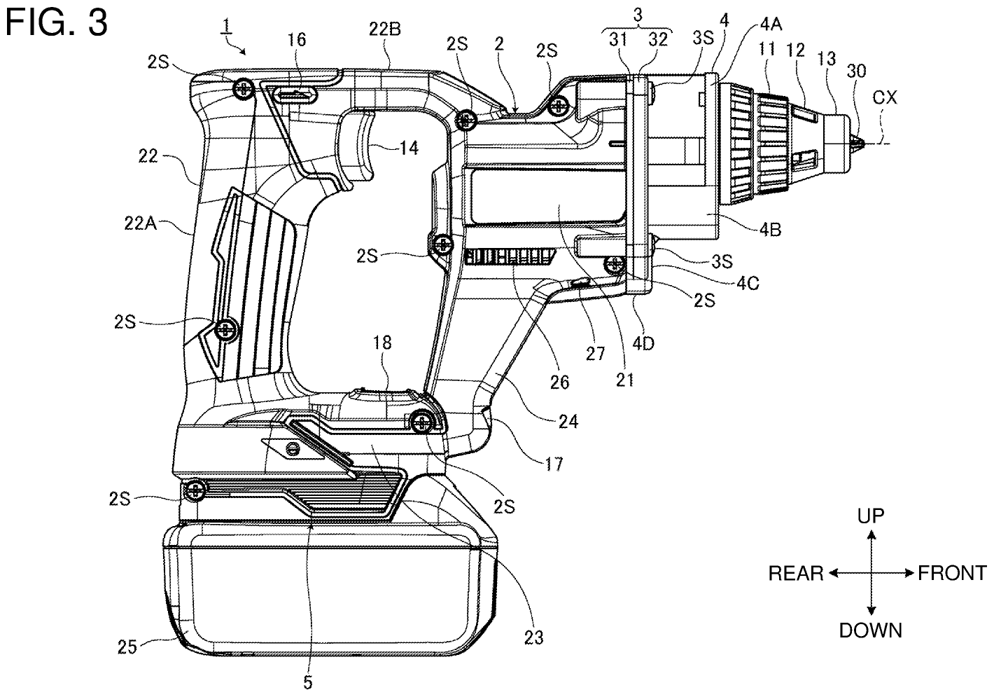

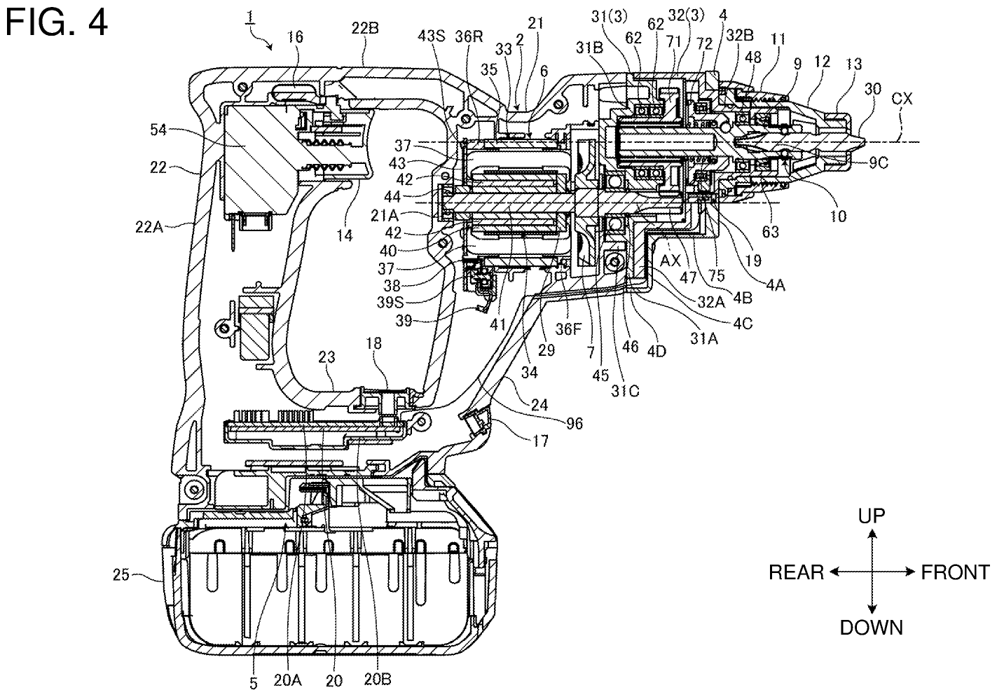

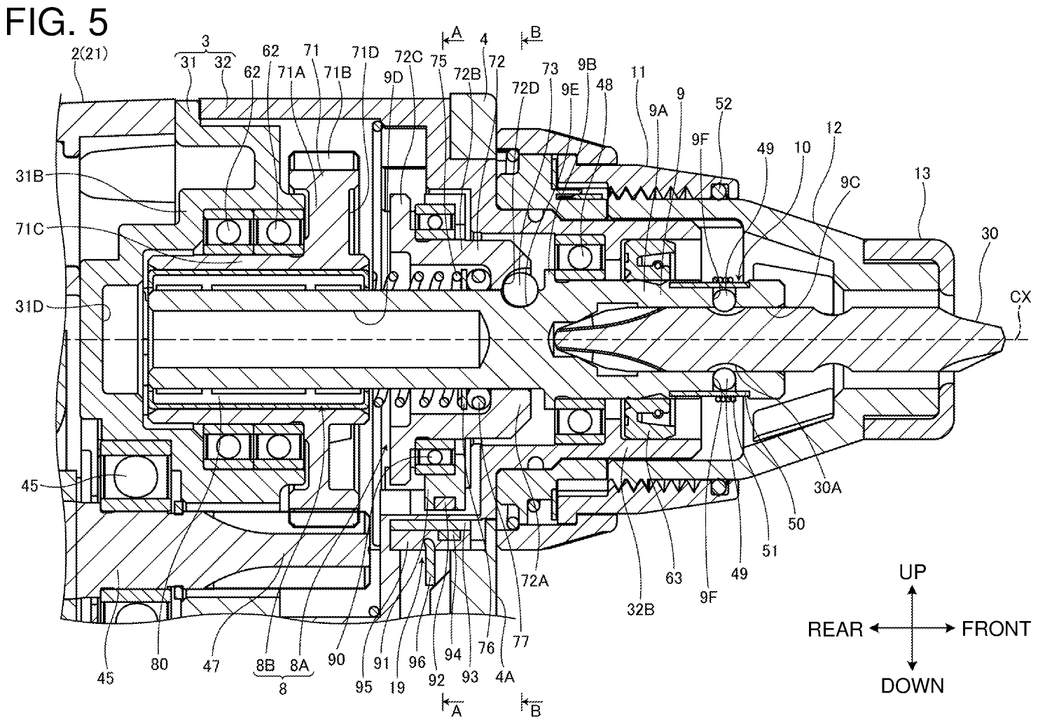

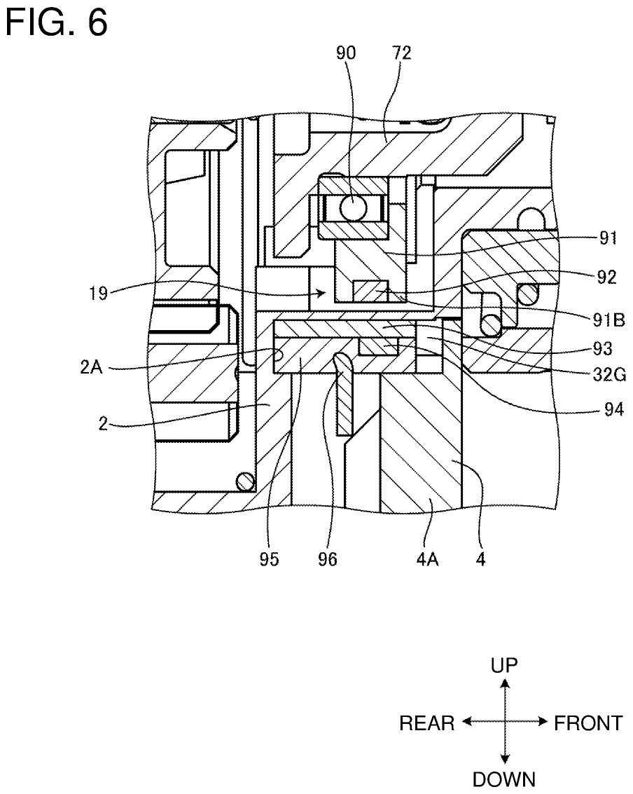

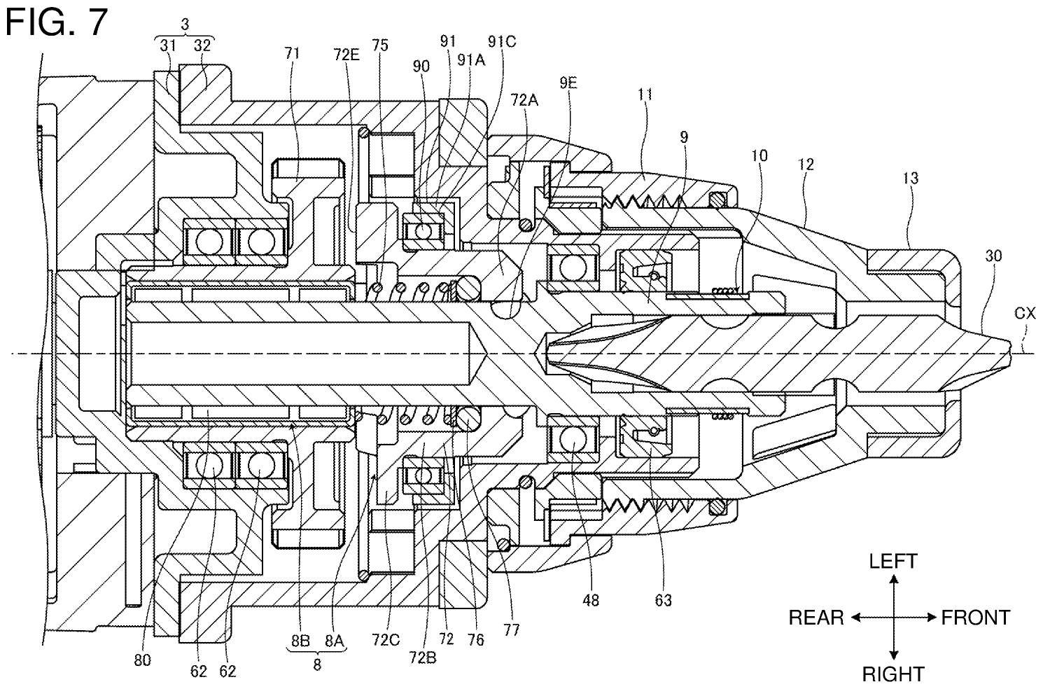

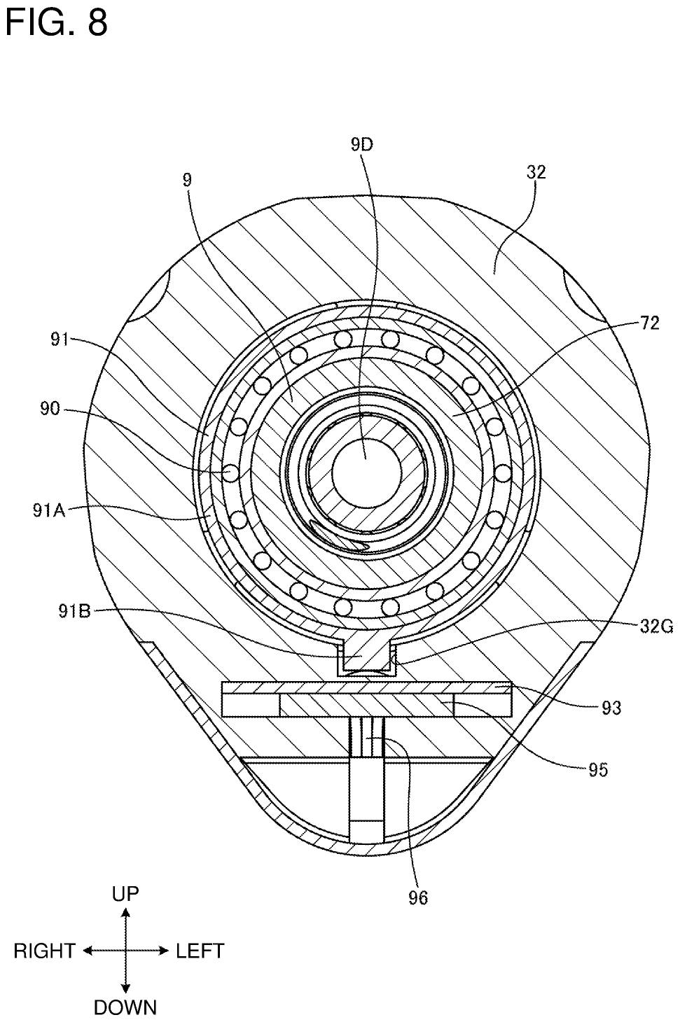

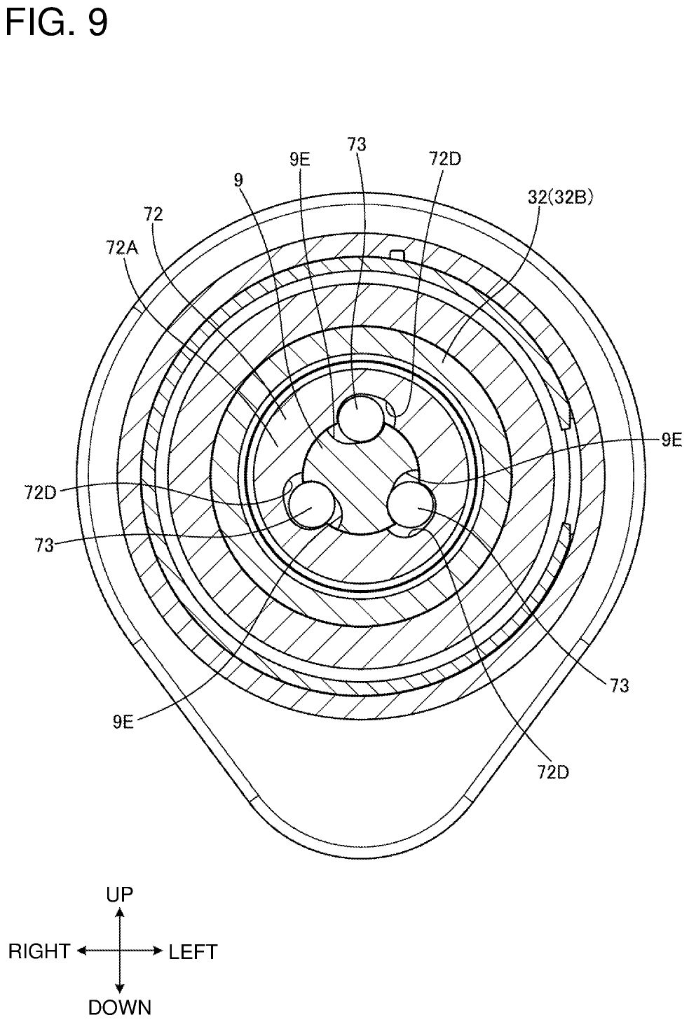

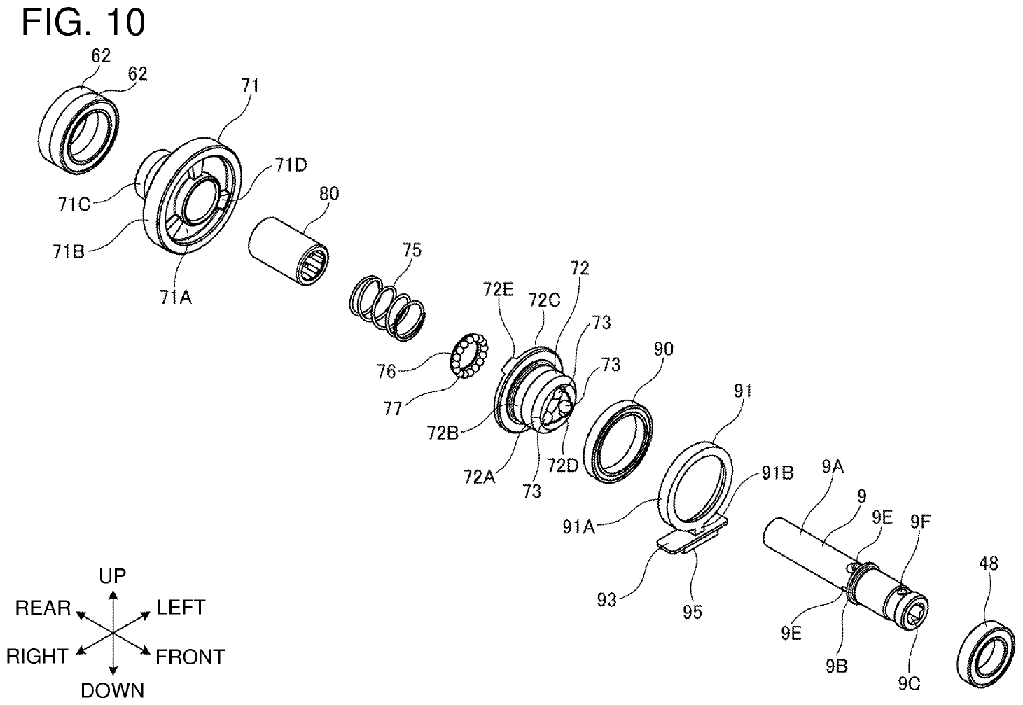

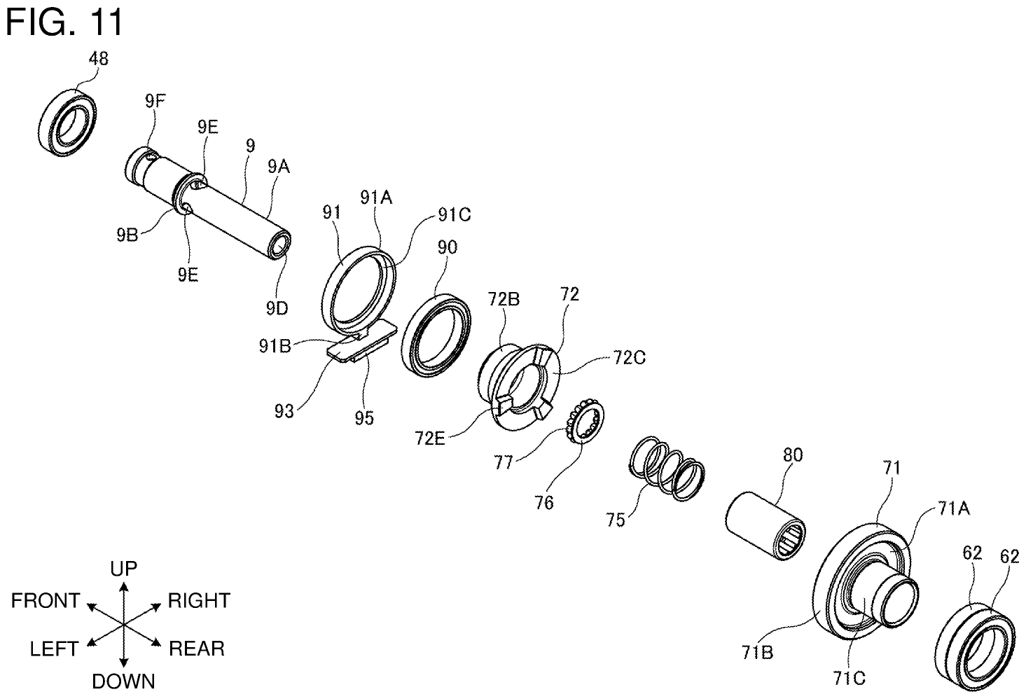

FIG. 1 is a perspective view of the screwdriver 1 according to an embodiment as viewed from the front. FIG. 2 is a perspective view of the screwdriver 1 as viewed from the rear. FIG. 3 is a side view of the screwdriver 1. FIG. 4 is a longitudinal sectional view of the screwdriver 1. FIG. 5 is a partially enlarged longitudinal sectional view of the screwdriver 1. FIG. 6 is a partially enlarged longitudinal sectional view of a main part of the screwdriver 1. FIG. 7 is a partial horizontal sectional view of the screwdriver 1. FIG. 8 is a cross-sectional view of the screwdriver 1, taken along line A-A as viewed in the direction indicated by the arrows in FIG. 5. FIG. 9 is a cross-sectional view of the screwdriver 1, taken along line B-B as viewed in the direction indicated by the arrows in FIG. 5. FIG. 10 is an exploded perspective view of the main part of the screwdriver 1 as viewed from the front. FIG. 11 is an exploded perspective view of the main part of the screwdriver 1 as viewed from the rear.

The screwdriver 1 includes a main housing 2, a gear housing 3, a cover 4, a battery mount 5, a motor 6, a fan 7, a power transmission 8, the spindle 9, a tool holder 10, a lock ring 11, an adjusting sleeve 12, a rubber cap 13, a trigger lever 14, a lock button 15, a forward-reverse switch lever 16, a light 17, a switch plate 18, a bit position detector 19, and a controller 20.

The main housing 2 accommodates at least parts of the components of the screwdriver 1. The main housing 2 includes a pair of housing halves. The main housing 2 includes a left housing 2L and a right housing 2R. The right housing 2R is located on the right of the left housing 2L. The left housing 2L and the right housing 2R are fastened together with multiple screws 2S.

The main housing 2 includes a motor compartment 21, a handle 22, a battery holder 23, and a joint 24.

The motor compartment 21 accommodates at least parts of the motor 6 and the power transmission 8. The motor compartment 21 is cylindrical. The motor compartment 21 extends in the front-rear direction.

The handle 22 is grippable by an operator. The handle 22 includes a grip 22A and a joint 22B. The grip 22A extends vertically. The joint 22B extends frontward from an upper portion of the grip 22A. The joint 22B has its front end connecting to the upper rear end of the motor compartment 21.

The battery holder 23 holds a battery pack 25 with the battery mount 5. The battery holder 23 accommodates the controller 20. The grip 22A has its lower end connecting to the rear of the battery holder 23.

The joint 24 connects a lower portion of the motor compartment 21 to the front of the battery holder 23.

The main housing 2 has a loop defined by the rear of the motor compartment 21, the joint 24, the battery holder 23, and the handle 22 connected together.

The motor compartment 21 has inlets 26 and outlets 27. The inlets 26 are located on the right and the left of the motor compartment 21. The outlets 27 are located in lower portions of the motor compartment 21. Air outside the main housing 2 flows into an internal space of the main housing 2 through the inlets 26, and flows out of the main housing 2 through the outlets 27.

The gear housing 3 accommodates at least a part of the power transmission 8. The gear housing 3 accommodates at least a part of the spindle 9. The gear housing 3 is at least partially located frontward from the main housing 2.

The gear housing 3 includes a rear housing 31 and a front housing 32. The front housing 32 is at least partially located frontward from the rear housing 31. The rear housing 31 is at least partially received in a front portion of the motor compartment 21. The front housing 32 is located frontward from the motor compartment 21.

The rear housing 31 includes a plate 31A, a recess 31B, and a cylinder 31C. The recess 31B is recessed rearward from an upper portion of the plate 31A. The cylinder 31C protrudes rearward from a lower portion of the plate 31A. The front housing 32 includes a plate 32A and a cylindrical portion 32B. The cylindrical portion 32B protrudes frontward from the plate 32A.

The gear housing 3 is fixed to the front portion of the motor compartment 21. The front portion of the motor compartment 21, the plate 31A on the rear housing 31, and the plate 32A on the front housing 32 are fastened together with three screws 3S.

The cover 4 covers at least a part of the gear housing 3. The cover 4 includes a first cover unit 4A, a second cover unit 4B, a third cover unit 4C, and a fourth cover unit 4D. The first cover unit 4A is a ring surrounding the front housing 32. The second cover unit 4B is located in a lower portion of the front housing 32. The third cover unit 4C faces a lower front surface of the plate 32A. The fourth cover unit 4D covers the lower end of the plate 31A and the lower end of the plate 32A.

The battery pack 25 is attached to the battery mount 5 in a detachable manner. The battery mount 5 is located in a lower portion of the battery holder 23. The battery pack 25 serves as a power supply for the screwdriver 1. The battery pack 25 is placed onto the battery mount 5 from the front of the battery holder 23 and is thus attached to the battery mount 5. The battery pack 25 is pulled forward along the battery mount 5 and is detached from the battery mount 5. The battery pack 25 includes a secondary battery. The battery pack 25 in the embodiment includes a rechargeable lithium-ion battery. The battery pack 25 is attached to the battery mount 5 to power the screwdriver 1. The battery pack 25 (battery) supplies power to the motor 6. The motor 6 is driven with power supplied from the battery pack 25. The controller 20 and the switch plate 18 each operate with power supplied from the battery pack 25.

The motor 6 is a power source for the screwdriver 1. The motor 6 is an electric motor drivable with power supplied from the battery pack 25. The motor 6 is an inner-rotor brushless motor. The motor 6 includes a stator 33 and a rotor 34. The stator 33 is supported by the motor compartment 21. The rotor 34 is at least partially located inward from the stator 33. The rotor 34 rotates relative to the stator 33. The rotor 34 rotates about the rotation axis AX extending in the front-rear direction.

The stator 33 includes a stator core 35, a rear insulator 36R, a front insulator 36F, and multiple coils 37.

The stator core 35 is located radially outward from the rotor 34 about the rotation axis AX. The stator core 35 includes multiple steel plates stacked on one another. The steel plates are metal plates containing iron as a main component. The stator core 35 is cylindrical. The stator core 35 includes multiple teeth to support the coils 37.

The rear insulator 36R is fixed to the rear of the stator core 35. The front insulator 36F is fixed to the front of the stator core 35. The rear insulator 36R and the front insulator 36F are electrical insulating members formed from a synthetic resin. The rear insulator 36R covers parts of the surfaces of the teeth on the stator core 35. The front insulator 36F covers parts of the surfaces of the teeth on the stator core 35.

The coils 37 are wound around the stator core 35 with the rear insulator 36R and the front insulator 36F in between. The coils 37 surround the teeth on the stator core 35 with the rear insulator 36R and the front insulator 36F in between. The stator core 35 and the coils 37 are electrically insulated from each other with the rear insulator 36R and the front insulator 36F. The coils 37 are connected to one another with a short-circuiting member 38. A current from the battery pack 25 is supplied to the coils 37 through the controller 20, a lead wire (not shown), and a connector 39 fixed to a lower portion of the rear insulator 36R. The connector 39 is fastened to the lower portion of the rear insulator 36R with a screw 39S.

The rotor 34 rotates about the rotation axis AX. The rotor 34 includes a rotor core 40, a rotor shaft 41, and a rotor magnet 42.

The rotor core 40 and the rotor shaft 41 are formed from steel. The rotor shaft 41 is fixed to the rotor core 40. The rotor core 40 is cylindrical. The rotor shaft 41 is located radially inward from the rotor core 40. The rotor shaft 41 includes a front portion protruding frontward from the front end face of the rotor core 40. The rotor shaft 41 includes a rear portion protruding rearward from the rear end face of the rotor core 40.

The rotor magnet 42 is fixed to the rotor core 40. The rotor magnet 42 is located inside the rotor core 40. The rotor magnet 42 is received in a magnet slot in the rotor core 40.

A sleeve 29 faces the front end face of the rotor core 40. The sleeve 29 is fixed to the rotor core 40 and the rotor shaft 41. The sleeve 29 adjusts the rotational balance of the rotor 34.

A rotation sensor board 43 is attached to the rear insulator 36R. The rotation sensor board 43 is fastened to the rear insulator 36R with screws 43S. The rotation sensor board 43 includes an annular circuit board and a magnetic sensor supported on the circuit board. The rotation sensor board 43 at least partially faces the rotor magnet 42. The magnetic sensor detects the position of the rotor magnet 42 to detect the position of the rotor 34 in the rotation direction. The magnetic sensor transmits a detection signal to the controller 20 through a lead wire (not shown).

The rotor shaft 41 has the rear end rotatably supported by a rotor bearing 44. The rotor shaft 41 includes the front portion rotatably supported by a rotor bearing 45. The rotor bearings 44 and 45 are ball bearings. The rotor bearing 44 is held in a recess 21A on the rear inner surface of the motor compartment 21. The rotor bearing 44 includes an inner ring with its front end in contact with a step on the rear portion of the rotor shaft 41. This restricts the rotor bearing 44 from moving relative to the rotor shaft 41 in the front-rear direction. The rotor bearing 45 is held by the cylinder 31C in the rear housing 31. The rotor bearing 45 includes an inner ring with its rear end in contact with a step on the front portion of the rotor shaft 41. A circlip 46 is located in front of the rotor bearing 45. The circlip 46 is in contact with the front end of the inner ring in the rotor bearing 45. This restricts the rotor bearing 45 from moving relative to the rotor shaft 41 in the front-rear direction. The rotor shaft 41 has its front end extending into the front housing 32 through an opening in the front end of the cylinder 31C.

A pinion gear 47 is fixed to the front end of the rotor shaft 41. The pinion gear 47 is rotatable about the rotation axis AX by the motor 6. The pinion gear 47 is connected to at least a part of the power transmission 8. The rotor shaft 41 is connected to the power transmission 8 with the pinion gear 47.

The fan 7 generates an airflow for cooling the motor 6. The fan 7 is located frontward from the stator 33. The fan 7 is between the rotor bearing 45 and the stator 33. The fan 7 is fixed to the rotor shaft 41 between the rotor bearing 45 and the stator 33. The fan 7 rotates as the rotor 34 rotates. As the rotor shaft 41 rotates, the fan 7 rotates together with the rotor shaft 41. As the fan 7 rotates, air outside the main housing 2 flows into the internal space of the main housing 2 through the inlets 26 and cools the motor 6. As the fan 7 rotates, the air passing through the internal space of the main housing 2 flows out of the main housing 2 through the outlets 27.

The power transmission 8 transmits a rotational force from the motor 6 to the spindle 9. The power transmission 8 rotates the spindle 9 at a lower rotational speed than the rotor shaft 41. The power transmission 8 in the embodiment includes a clutch assembly 8A and a spindle locking assembly 8B. During forward rotation of the motor 6, the clutch assembly 8A transmits a rotational force from the motor 6 to the spindle 9. The spindle locking assembly 8B transmits a rotational force from the motor 6 to the spindle 9 during reverse rotation of the motor 6.

The power transmission 8 includes a drive gear 71, a clutch cam 72, balls 73, a compression spring 75, a washer 76, balls 77, and a one-way needle bearing 80.

The clutch assembly 8A includes the clutch cam 72 and the compression spring 75. The clutch cam 72 is connected to the spindle 9 with the balls 73 in between. The compression spring 75 urges the clutch cam 72 and the spindle 9 forward. The drive gear 71, the clutch cam 72, and the compression spring 75 are located in the gear housing 3.

The spindle locking assembly 8B includes the one-way needle bearing 80 surrounding the spindle 9. The one-way needle bearing 80 is located inside the gear housing 3.

The drive gear 71 meshes with the pinion gear 47. The drive gear 71 meshing with the pinion gear 47 rotates about the rotation axis CX. The drive gear 71 is a helical gear. The drive gear 71 is located above the pinion gear 47. The pinion gear 47 rotates about the rotation axis AX as the rotor shaft 41 in the motor 6 rotates. This causes the drive gear 71 to rotate about the rotation axis CX. The drive gear 71 includes a ring 71A, a gear 71B, a cylindrical portion 71C, and drive cams 71D. The ring 71A surrounds the rotation axis CX. The gear 71B is located on the outer circumference of the ring 71A. The gear 71B meshes with the pinion gear 47. The cylindrical portion 71C protrudes rearward from the rear surface of the ring 71A. The cylindrical portion 71C surrounds the one-way needle bearing 80. The drive cams 71D protrude frontward from the front surface of the ring 71A. The drive cams 71D rotate about the rotation axis CX as driven by the drive gear 71. The drive gear 71 is accommodated in the rear housing 31.

The one-way needle bearing 80 surrounds the spindle 9. The drive gear 71 is supported by the spindle 9 with the one-way needle bearing 80 in between.

The clutch cam 72 is located frontward from the drive gear 71. The clutch cam 72 surrounds the spindle 9. The clutch cam 72 is connected to the spindle 9 with multiple balls 73 in between. The clutch cam 72 is supported by the spindle 9 with the balls 73 in between. The clutch cam 72 includes a support ring 72A, a cylindrical portion 72B, a cam ring 72C, cam ball grooves 72D, and follower cams 72E. The support ring 72A surrounds the rotation axis CX. The cylindrical portion 72B extends rearward from the support ring 72A. The cam ring 72C extends radially outward from the rear end of the cylindrical portion 72B. The cam ball grooves 72D are located on the support ring 72A. The cam ball grooves 72D receive at least parts of the balls 73. The follower cams 72E protrude rearward from the rear surface of the cam ring 72C.

The power transmission 8 in the embodiment includes three balls 73. Three cam ball grooves 72D are located on the front of the support ring 72A. The three cam ball grooves 72D are arc-shaped in a plane orthogonal to the rotation axis CX. The cam ball grooves 72D are at least partially sloped in the front-rear direction. The cam ball grooves 72D surround the rotation axis CX. Each cam ball groove 72D receives one ball 73.

The spindle 9 has spindle ball grooves 9E. The spindle ball grooves 9E receive at least parts of the balls 73. Three spindle ball grooves 9E are located on the outer circumferential surface of the spindle 9. The three spindle ball grooves 9E are arc-shaped in a plane orthogonal to the rotation axis CX. The spindle ball grooves 9E surround the rotation axis CX. Each spindle ball groove 9E receives one ball 73.

The compression spring 75 surrounds the spindle 9. The compression spring 75 urges the clutch cam 72 and the spindle 9 forward. The compression spring 75 is located inside the cylindrical portion 72B of the clutch cam 72. The washer 76 and the balls 77 surround the spindle 9 inside the cylindrical portion 72B of the clutch cam 72. Multiple balls 77 surround the spindle 9. The balls 77 are in contact with the rear surface of the support ring 72A. The washer 76 is located behind the balls 77. The compression spring 75 has its front end in contact with the rear surface of the washer 76. The compression spring 75 has its rear end connected to the front end of the one-way needle bearing 80. The compression spring 75 urges the clutch cam 72 forward with the washer 76 and the balls 77 in between. The spindle 9 is connected to the clutch cam 72 with the balls 73 in between. The compression spring 75 urges the clutch cam 72 forward. This also urges the spindle 9 forward together with the clutch cam 72.

The spindle 9 rotates under a rotational force from the motor 6. The spindle 9 is at least partially located frontward from the power transmission 8. The spindle 9 is at least partially located frontward from the drive gear 71. The spindle 9 supporting the drive gear 71 rotates about the rotation axis CX. The rotation axis AX of the motor 6 is different from the rotation axis CX of the spindle 9. The rotation axis AX and the rotation axis CX are parallel to each other. The spindle 9 is rotatable by the rotor 34. The spindle 9 rotates under a rotational force from the rotor 34 transmitted by the power transmission 8. The spindle 9 holds a screwdriver bit 30 as a tip tool and rotates together with the screwdriver bit 30. The spindle 9 rotates about the rotation axis CX with the screwdriver bit 30 attached to the spindle 9.

The spindle 9 includes a rod 9A, a stopper 9B, a bit holding hole 9C, a hollow portion 9D, the spindle ball grooves 9E, and a through-hole 9F. The rod 9A extends in the front-rear direction. The stopper 9B protrudes radially outward from a front portion of the outer circumferential surface of the rod 9A. The bit holding hole 9C extends rearward from the front end face of the rod 9A. The screwdriver bit 30 is attached to the rod 9A. The screwdriver bit 30 is placed into the bit holding hole 9C from the front of the bit holding hole 9C. The bit holding hole 9C has a hexagonal cross section in a direction orthogonal to the rotation axis CX. The hollow portion 9D extends frontward from the rear end face of the spindle 9. The hollow portion 9D reduces the weight of the spindle 9. An oil seal 63 surrounds the rod 9A. The oil seal 63 is held on the cylindrical portion 32B of the front housing 32.

The spindle 9 includes its rear portion rotatably supported by spindle rear bearings 62. Two spindle rear bearings 62 are arranged in the front-rear direction. The spindle rear bearings 62 are located rearward from the drive gear 71. The spindle 9 has its front portion rotatably supported by spindle front bearings 48.

The two spindle rear bearings 62 reduce axial wobbling of the spindle 9. This allows appropriate meshing between the pinion gear 47 and the drive gear 71.

The spindle front bearings 48 are held on the front housing 32. The spindle front bearings 48 each include an outer ring with its front end face supported by a protrusion protruding radially inward from the inner circumferential surface of the cylindrical portion 32B of the front housing 32. The stopper 9B on the spindle 9 can come in contact with the rear end face of the outer ring in the spindle front bearing 48. The spindle 9 is rotatably supported by the spindle front bearings 48 at a position frontward from the drive gear 71. The spindle 9 is supported by the front housing 32 at a position frontward from the drive gear 71 in a manner movable in the front-rear direction. The spindle 9 is supported by the gear housing 3 at a position frontward from the drive gear 71 with the spindle front bearings 48 in between in a manner movable in the front-rear direction. The spindle 9 is movable in the front-rear direction between an advanced position and a retracted position. The retracted position is rearward from the advanced position. The clutch cam 72 moves in the front-rear direction together with the spindle 9.

The follower cams 72E in the clutch cam 72 are located frontward from the drive cams 71D in the drive gear 71. The drive cams 71D face the follower cams 72E. The spindle 9 is supported on the gear housing 3 with the spindle front bearings 48 in between. The spindle 9 is thus movable in the front-rear direction to allow the follower cams 72E to come in or out of contact with the drive cams 71D. The follower cams 72E move in the front-rear direction together with the spindle 9 to come in or out of contact with the drive cams 71D. At the advanced position of the spindle 9, the follower cams 72E come out of contact with the drive cams 71D. At the retracted position of the spindle 9, the follower cams 72E come in contact with the drive cams 71D.

The tool holder 10 holds the screwdriver bit 30 received in the bit holding hole 9C. The tool holder 10 includes balls 49, a ring 50, and a spring 51. The balls 49 are received in through-holes 9F connecting the outer circumferential surface of the spindle 9 and the inner circumferential surface of the bit holding hole 9C. The ring 50 is located radially outward from the balls 49 about the rotation axis CX. The spring 51 is located outward from the ring 50. The spring 51 presses the balls 49 radially inward with the ring 50 in between. The balls 49 are at least partially received in a recess 30A on the screwdriver bit 30. This restricts the screwdriver bit 30 from slipping off the bit holding hole 9C.

The lock ring 11 is operable by the operator to adjust the degree by which the screwdriver bit 30 protrudes from the front end face of the rubber cap 13. The lock ring 11 surrounds the cylindrical portion 32B of the front housing 32. The lock ring 11 is rotatable relative to the front housing 32. The lock ring 11 is rotated to move in the front-rear direction relative to the front housing 32. In response to the lock ring 11 rotated in one direction, the screwdriver bit 30 protrudes by a greater degree. In response to the lock ring 11 rotated in the other direction, the screwdriver bit 30 protrudes by a lesser degree.

The adjusting sleeve 12 is attached to the lock ring 11 in a detachable manner. The adjusting sleeve 12 is attached to the lock ring 11 with an O-ring 52 in between. The adjusting sleeve 12 surrounds the spindle 9 at a position frontward from the lock ring 11. The adjusting sleeve 12 is substantially cylindrical. The adjusting sleeve 12 is tapered with its diameter decreasing frontward. The adjusting sleeve 12 moves in the front-rear direction together with the lock ring 11 as the lock ring 11 is rotated.

The rubber cap 13 is attached to the front end of the adjusting sleeve 12. The rubber cap 13 is fixed to the front end of the adjusting sleeve 12. The rubber cap 13 surrounds the screwdriver bit 30 attached to the spindle 9. In a screwing operation using the screwdriver 1, the rubber cap 13 comes in contact with a workpiece. The rubber cap 13 reduces damage on the workpiece.

The screwdriver bit 30 placed in the bit holding hole 9C and held by the tool holder has its front end located frontward from the front end of the rubber cap 13. To adjust the depth of a screw tightened into the workpiece, the operator rotates the lock ring 11 to move the lock ring 11 in the front-rear direction. This also moves the adjusting sleeve 12 and the rubber cap 13 in the front-rear direction together with the lock ring 11. The degree by which the screwdriver bit 30 protrudes from the front end face of the rubber cap 13 is thus adjusted. This adjusts the depth of the screw tightened into the workpiece.

The trigger lever 14 is operable by the operator to activate the motor 6. The trigger lever 14 is located on the grip 22A. The trigger lever 14 protrudes frontward from an upper front portion of the grip 22A. A switch 54 is located behind the trigger lever 14. The switch 54 is accommodated in the grip 22A. The trigger lever 14 is connected to the switch 54. When the trigger lever 14 is pulled to move backward, an operation signal is output from the switch 54 to the controller 20. The controller 20 drives the motor 6 in response to the operation signal from the switch 54. When the trigger lever 14 is released from being operated, the motor 6 is stopped.

The lock button 15 retains the trigger lever 14 being pulled. The lock button 15 is located on the upper left of the grip 22A. When the lock button 15 is pressed with the trigger lever 14 being pulled, the trigger lever 14 remains pulled and the motor 6 remains driven after the operator releases the trigger lever 14.

The forward-reverse switch lever 16 is operable to switch the rotation direction of the motor 6. The forward-reverse switch lever 16 is located on the joint 22B. The forward-reverse switch lever 16 is operable to switch the rotation direction of the motor 6 between forward and reverse. This switches the rotation direction of the spindle 9. When the forward-reverse switch lever 16 is at a neutral position, the trigger lever 14 is inoperable.

The light 17 emits illumination light. The light 17 includes a light-emitting diode (LED). The light 17 is located in a lower front portion of the joint 24. The light 17 illuminates an area ahead of the spindle 9 with illumination light.

The switch plate 18 includes a mode switch button 18A operable by the operator. The switch plate 18 is located on the battery holder 23. The switch plate 18 is located on the upper surface of the battery holder 23 between the lower end of the grip 22A and the lower end of the joint 24. In response to an operation on the mode switch button 18A performed by the operator, the operation mode of the motor 6 is switched. The operation mode of the motor 6 in the embodiment includes a normal mode and a push-drive mode (also referred to as an auto-start mode). In the normal mode, the trigger lever 14 is pulled to activate the motor 6. In the push-drive mode, the motor 6 is not activated immediately after the trigger lever 14 is pulled. The motor 6 is activated in response to detection of the spindle 9 moving backward from the advanced position together with the screwdriver bit 30. The operator operates the mode switch button 18A to set the operation mode of the screwdriver 1 to either the normal mode or the push-drive mode.

When the motor 6 is operated in the push-drive mode, the bit position detector 19 detects the spindle 9 moving backward from the advanced position together with the screwdriver bit 30.

The bit position detector 19 includes a bearing 90, a movable member 91, a magnet 92, and a mode sensor board 93.

The bearing 90 surrounds the cylindrical portion 72B of the clutch cam 72. The bearing 90 supports the clutch cam 72 in a rotatable manner.

The movable member 91 surrounds the spindle 9. The bearing 90 is between the spindle 9 and the movable member 91. The movable member 91 in the embodiment surrounds the clutch cam 72. The bearing 90 is between the clutch cam 72 and the movable member 91. The movable member 91 is connected to the clutch cam 72 with the bearing 90 in between.

The spindle 9 is movable in the front-rear direction between the advanced position and the retracted position. The clutch cam 72 moves in the front-rear direction together with the spindle 9. The movable member 91 and the bearing 90 move in the front-rear direction together with the spindle 9 and the clutch cam 72. In other words, the spindle 9, the clutch cam 72, the bearing 90, and the movable member 91 move together in the front-rear direction relative to the front housing 32. The clutch cam 72 is a push-in clutch located frontward from the motor 6 and is driven by the motor 6. The spindle 9 is located frontward from the clutch cam 72, which is a push-in clutch, and is driven by the clutch cam 72. As shown in FIG. 5, the recess 31B on the rear housing 31 has a receiving recess 31D in its rear portion. The receiving recess 31D receives the rear end of the spindle 9 at the retracted position.

The movable member 91 includes a ring 91A and a protrusion 91B. The ring 91A surrounds the bearing 90. The protrusion 91B protrudes downward from the ring 91A. As shown in FIG. 8, a recess 32G is located on the inner circumferential surface of the front housing 32. The protrusion 91B is received in the recess 32G. This restricts the movable member 91 from rotating relative to the front housing 32. In other words, the movable member 91 is locked in a nonrotatable manner with the protrusion 91B and the recess 32G. The protrusion 91B and the recess 32G serve as a rotation locking assembly that restricts the rotation of the movable member 91 relative to the front housing 32. The clutch cam 72 is rotatably supported by the movable member 91 with the bearing 90 in between. The clutch cam 72 and the spindle 9 are rotatable relative to the movable member 91 and the front housing 32. The recess 32G extends in the front-rear direction. The protrusion 91B is movable in the front-rear direction inside the recess 32G. The recess 32G serves as a guide to guide the movable member 91 in the front-rear direction.

The magnet 92 is located frontward from the spindle rear bearings 62. The magnet 92 is located frontward from the drive gear 71. The magnet 92 is movable in the front-rear direction in synchronization with the spindle 9. The magnet 92 in the embodiment is fixed to the protrusion 91B on the movable member 91. The magnet 92 may be buried inside the movable member 91. The magnet 92 and at least a part of the spindle 9 are aligned with each other in the front-rear direction. The magnet 92 is movable in the front-rear direction together with the movable member 91.

The mode sensor board 93 includes a circuit board. A magnetic sensor 94 is mounted on the mode sensor board 93. The magnetic sensor 94 detects the magnet 92. The mode sensor board 93 including the magnetic sensor 94 is located radially outward from the rotation axis CX. The mode sensor board 93 is located frontward from the spindle rear bearings 62. The mode sensor board 93 is located frontward from the drive gear 71. The mode sensor board 93 and at least a part of the spindle 9 are aligned with each other in the front-rear direction. The mode sensor board 93 at least partially faces the magnet 92 fixed to the movable member 91. The mode sensor board 93 is supported on the main housing 2. The mode sensor board 93 is located outside (below) the front housing 32. Grease applied to the spindle 9, the drive gear 71, the clutch cam 72, and other components is thus less likely to adhere to the mode sensor board 93. Heat generated in the spindle 9, the drive gear 71, the clutch cam 72, and other components is less likely to be transferred to the mode sensor board 93. The mode sensor board 93 including the magnetic sensor 94 is thus less likely to deteriorate or break. The mode sensor board 93 may be supported on the front housing 32.

The mode sensor board 93 is located below the magnet 92. The magnetic sensor 94 is mounted on the lower surface of the mode sensor board 93. The magnetic sensor 94 in the embodiment is covered with a resin layer 95. As shown in FIG. 6, a recess 2A is located on at least a part of the main housing 2. The mode sensor board 93 including the resin layer 95 is fitted in the recess 2A. The magnetic sensor 94 may be mounted on the upper surface of the mode sensor board 93. The resin layer 95 may be eliminated.

The magnetic sensor 94 detects a change in the magnetic field of the magnet 92 to detect the movement of the movable member 91. The magnetic sensor 94 transmits a detection signal to the controller 20 through a lead wire 96. The magnetic sensor 94 is located radially outward from the clutch cam 72, which is a push-in clutch. The magnetic sensor 94 serves as a push-in sensor to detect the clutch cam 72 being pushed in.

The controller 20 outputs a control signal for controlling the motor 6. The controller 20 is accommodated in the battery holder 23. The controller 20 controls the motor 6 in the operation mode set through an operation on the mode switch button 18A. The controller includes a circuit board 20A and a case 20B. The circuit board 20A incorporates multiple electronic components. The case 20B accommodates the circuit board 20A. Examples of the electronic components mounted on the circuit board 20A include a processor such as a central processing unit (CPU), a nonvolatile memory such as a read-only memory (ROM) or a storage device, a volatile memory such as a random-access memory (RAM), at least six switching elements, a transistor, and a resistor.

The controller 20 controls the motor 6 based on detection signals from the magnetic sensor 94. In the normal mode, the controller 20 activates the motor 6 in response to an operation signal indicating the trigger lever 14 being pulled. In the push-drive mode, the controller 20 activates the motor 6 in response to an operation signal indicating the trigger lever 14 being pulled and to a detection signal, from the magnetic sensor 94, indicating that the movable member 91 has moved backward and the magnet 92 has moved relative to the mode sensor board 93.

### Clutch Assembly

The clutch assembly 8A transmits a rotational force from the rotor 34 in the motor 6 to the spindle 9 when the spindle 9 moves to the retracted position during forward rotation of the motor 6. The clutch assembly 8A includes the drive cams 71D and the follower cams 72E. The drive cams 71D are included in the drive gear 71. The follower cams 72E are included in the clutch cam 72 and face the drive cams 71D. The clutch cam 72 surrounds the spindle 9. The clutch cam 72 is connected to the spindle 9 with the balls 73 in between. The clutch assembly 8A includes the compression spring 75 that urges the clutch cam 72 and the spindle 9 forward.

To perform a screwing operation on a workpiece, the forward-reverse switch lever 16 is operated to cause the rotor 34 in the motor 6 to rotate in the forward direction. After the screwdriver bit 30 is placed in the bit holding hole 9C and is attached to the rod 9A, the operator grips the handle 22 and places the tip of the screwdriver bit 30 into a cross slot on the head of a screw on the surface of the workpiece. The operator then pulls the trigger lever 14.

### Normal Mode

The operation of the screwdriver 1 in the normal mode will now be described. In the normal mode, the trigger lever 14 is pulled to activate the motor 6. As the motor 6 is activated and the rotor 34 rotates forward, rotation of the rotor shaft 41 is transmitted to the drive gear 71 through the pinion gear 47, thus rotating the drive gear 71. With the rotor 34 rotating forward, the drive gear 71 and the spindle 9 rotate relative to each other under the effect of the one-way needle bearing 80 between the drive gear 71 and the spindle 9. In other words, with the rotor 34 rotating forward, the drive gear 71 rotates, but the spindle 9 does not rotate under the effect of the one-way needle bearing 80.

At the advanced position of the spindle 9 with the rotor 34 rotating forward, the drive cams 71D are out of contact with the follower cams 72E. Thus, a rotational force is not transmitted from the drive gear 71 to the clutch cam 72 as the drive gear 71 rotates.

With the drive gear 71 rotating, the operator grips the handle 22 and presses the screwdriver 1 against the workpiece to place the screwdriver 1 closer to the workpiece (pressing operation). This causes the spindle 9, together with the screwdriver bit 30, to move backward against an elastic force from the compression spring 75.

When the spindle 9 moves to the retracted position, the drive cams 71D come in contact with the follower cams 72E. When the spindle 9 moves from the advanced position to the retracted position and the drive cams 71D come in contact with the follower cams 72E, the clutch cam 72 receives a resistance force in the rotation direction from the spindle 9. This causes the balls 73 to roll between the spindle ball grooves 9E and the cam ball grooves 72D. The spindle 9 and the clutch cam 72 thus rotate relative to each other with the balls 73 in between. Each ball 73 moves from one end to the other end of the corresponding cam ball groove 72D in the circumferential direction and stops at the other end of the corresponding cam ball groove 72D. This causes the spindle 9 and the clutch cam 72 to rotate together. In the embodiment, the cam ball grooves 72D are at least partially sloped in the front-rear direction. This causes the clutch cam 72 to move backward when the spindle 9 and the clutch cam 72 rotate relative to each other with the balls 73 in between with the drive cams 71D in contact with the follower cams 72E.

The spindle 9 and the clutch cam 72 move backward with the drive cams 71D in contact with the follower cams 72E. When the motor 6 is driven in this state, the spindle 9 and the clutch cam 72 rotate under rotation of the drive gear 71. The spindle 9 rotates under a rotational force from the drive gear 71 transmitted through the clutch assembly 8A, which includes the drive cams 71D and the follower cams 72E. The screwdriver bit 30 rotates forward together with the spindle 9 to drive the screw into the workpiece.

During a screwing operation, the operator continues the pressing operation on the screwdriver 1. As the screwing operation continues, the screwdriver 1 gradually approaches the workpiece, and then the front end of the rubber cap 13 comes in contact with the workpiece. As the screwing operation continues, the spindle 9 moves forward while rotating. Although the torque applied from the screw to the spindle 9 through the screwdriver bit 30 is large in the initial stage of the screwing operation, the torque applied from the screw to the spindle 9 through the screwdriver bit 30 decreases at the end of the screwing operation. A contact force between the drive cams 71D and the follower cams 72E then decreases. The clutch cam 72 moves forward under an urging force from the compression spring 75. The drive cams 71D thus come out of contact with the follower cams 72E, stopping the rotation of the spindle 9. This completes the screwing operation.

After the drive cams 71D come out of contact with the follower cams 72E and the spindle 9 stops rotating, the motor 6 continues driving while the trigger lever 14 is being pulled. When the trigger lever 14 is released from being operated, the motor 6 is stopped. When the pressing operation is released and the screwdriver bit 30 is separate from the screw, the spindle 9 returns to the advanced position under an urging force from the compression spring 75.

### Push-Drive Mode

The operation of the screwdriver 1 in the push-drive mode will now be described. In the push-drive mode, pulling the trigger lever 14 alone does not activate the motor 6. When the spindle 9 moves backward in response to the pressing operation performed on the screwdriver 1 with the trigger lever 14 being pulled, the movable member 91 moves backward together with the spindle 9. The magnet 92 then moves relative to the mode sensor board 93. In response to a change in the magnetic field detected by the magnetic sensor 94 on the mode sensor board 93, the controller 20 activates the motor 6. This causes the drive gear 71 to start rotating. As the pressing operation continues, the spindle 9 moves toward the retracted position. When the spindle 9 moves to the retracted position and the drive cams 71D come in contact with the follower cams 72E, the spindle 9 rotates under a rotational force from the drive gear 71 transmitted through the clutch assembly 8A, which includes the drive cams 71D and the follower cams 72E. The screwdriver bit 30 rotates forward together with the spindle 9 to drive a screw into the workpiece.

As the screwing operation continues, the screwdriver 1 gradually approaches the workpiece, and then the front end of the rubber cap 13 comes in contact with the workpiece. As less torque is applied to the spindle 9 through the screwdriver bit 30, the clutch cam 72 moves forward under an urging force from the compression spring 75. The drive cams 71D thus come out of contact with the follower cams 72E, stopping the rotation of the spindle 9. This completes the screwing operation.

When the pressing operation is released after completion of the screwing operation and the screwdriver bit 30 is separate from the screw, the spindle 9 returns to the advanced position under an urging force from the compression spring 75. The movable member 91 and the magnet 92 also return to the advance position. The controller 20 stops the motor 6 in response to a change in the magnetic field detected by the magnetic sensor 94 on the mode sensor board 93.

### Spindle Locking Assembly

The spindle locking assembly 8B transmits a rotational force from the rotor 34 in the motor 6 to the spindle 9 during reverse rotation of the motor 6. The spindle locking assembly 8B includes the one-way needle bearing 80 surrounding the spindle 9. The drive gear 71 and the spindle 9 are locked together by the one-way needle bearing 80 during reverse rotation of the rotor 34. In other words, the one-way needle bearing 80 locks the drive gear 71 and the spindle 9 to prevent relative rotation between the drive gear 71 and the spindle 9. The drive gear 71 and the spindle 9 do not rotate relative to each other but rotate together during reverse rotation of the rotor 34. The rotation of the drive gear 71 is thus transmitted to the spindle 9 although the drive cams 71D are out of contact with the follower cams 72E. To perform an unscrewing operation to remove a screw from a workpiece, the motor 6 rotates in the reverse direction. In an unscrewing operation, the spindle 9 can rotate without moving from the advanced position to the retracted position. Thus, the spindle 9 rotates without the pressing operation on the screwdriver 1 to place the screwdriver 1 closer to the workpiece.

As described above, the screwdriver 1 according to the embodiment includes the gear housing 3, the motor 6, the pinion gear 47, the drive gear 71, the spindle 9, the drive cams 71D, the follower cams 72E, the spindle 9 (support shaft), the spindle rear bearings 62 (first bearing), the magnet 92, the magnetic sensor 94, and the controller 20. The pinion gear 47 is rotatable by the motor 6. The drive gear 71 meshing with the pinion gear 47 is rotatable about the rotation axis CX (first rotation axis). The spindle 9 is located frontward from the drive gear 71 and supported by the gear housing 3 in a manner movable in the front-rear direction. The spindle 9 is rotatable about the rotation axis CX with the screwdriver bit 30 (tip tool) being attached to the spindle 9. The drive cams 71D are rotatable about the rotation axis CX by the drive gear 71. The follower cams 72E are located frontward from the drive cams 71D and movable in the front-rear direction together with the spindle 9 to come in or out of contact with the drive cams 71D. The spindle 9 supporting the drive gear 71 is rotatable about the rotation axis CX. The spindle rear bearings 62 are located rearward from the drive gear 71 and support the spindle 9 in a rotatable manner. The magnet 92 is located frontward from the spindle rear bearings 62 and movable in the front-rear direction in synchronization with the spindle 9. The magnetic sensor 94 is located radially outward from the rotation axis CX to detect the magnet 92. The controller 20 controls the motor 6 in response to a detection signal from the magnetic sensor 94.

In the above structure, the magnet 92 and the magnetic sensor 94 are located frontward from the spindle rear bearings 62. The screwdriver 1 is thus less likely to have an increased overall length. The overall length of the screwdriver 1 refers to the distance in the front-rear direction between the rear end of the motor 6 and the front end of the spindle 9. The overall length of the screwdriver 1 may be the distance in the front-rear direction between the rear end of the motor 6 and the front end of the rubber cap 13.

The magnet 92 in the embodiment is located frontward from the drive gear 71.

In the above structure, the magnet 92 and the magnetic sensor 94 are located frontward from the drive gear 71. The screwdriver 1 is thus less likely to have an increased overall length.

In the embodiment, the magnet 92 and at least a part of the spindle 9 are aligned with each other in the front-rear direction.

The screwdriver 1 is thus less likely to have an increased overall length.

The screwdriver 1 according to the embodiment includes the movable member 91 surrounding the spindle 9 and is movable in the front-rear direction together with the spindle 9. The magnet 92 is fixed to the movable member 91.

This allows the magnet 92 to move in the front-rear direction together with the spindle 9.

The screwdriver 1 according to the embodiment includes the bearing 90 (second bearing) between the spindle 9 and the movable member 91, and the rotation locking assembly including the protrusion 91B and the recess 32G that restricts rotation of the movable member 91 relative to the gear housing 3.

The movable member 91 is thus nonrotatable, allowing the magnetic sensor 94 to appropriately detect the magnet 92 fixed to the movable member 91. The bearing 90 also allows the spindle 9 to rotate.

The screwdriver 1 according to the embodiment includes the clutch cam 72 surrounding the spindle 9 and connected to the spindle 9 with the balls 73 in between. The clutch cam 72 includes the follower cams 72E. The movable member 91 surrounds the clutch cam 72. The bearing 90 is between the clutch cam 72 and the movable member 91.

The spindle 9, the clutch cam 72, the bearing 90, and the movable member 91 to which the magnet 92 is fixed move together in the front-rear direction, thus reducing structural complexity.

The screwdriver 1 according to the embodiment has the recess 32G serving as a guide to guide the movable member 91 in the front-rear direction.

The movable member 91 is thus appropriately movable in the front-rear direction.

The drive cams 71D in the embodiment are included in the drive gear 71.

The screwdriver 1 thus includes fewer components.

The screwdriver 1 according to the embodiment includes the motor 6, the clutch cam 72 (push-in clutch), the spindle 9, the magnetic sensor 94 (push-in sensor), and the battery pack (battery). The clutch cam 72 is located frontward from the motor 6 and drivable by the motor 6. The spindle 9 is located frontward from the clutch cam 72 and drivable by the clutch cam 72. The magnetic sensor 94 is located radially outward from and below the clutch cam 72. The magnetic sensor 94 detects the clutch cam 72 being pushed in. The battery pack 25 powers the motor 6.

In the above structure, the magnetic sensor 94 (push-in magnetic sensor) is located radially outward from the clutch cam 72 (push-in clutch). The screwdriver 1 is thus less likely to have an increased overall length.

The magnetic sensor 94 may be fixed directly or indirectly to the clutch cam 72. For the magnetic sensor 94 fixed indirectly to the clutch cam 72, the magnetic sensor 94 is fixed with one or more separate components. In other words, the magnetic sensor 94 may be located radially outward from the clutch cam 72. The magnetic sensor 94 is between the front end and the rear end of the clutch cam 72.

### Other Embodiments

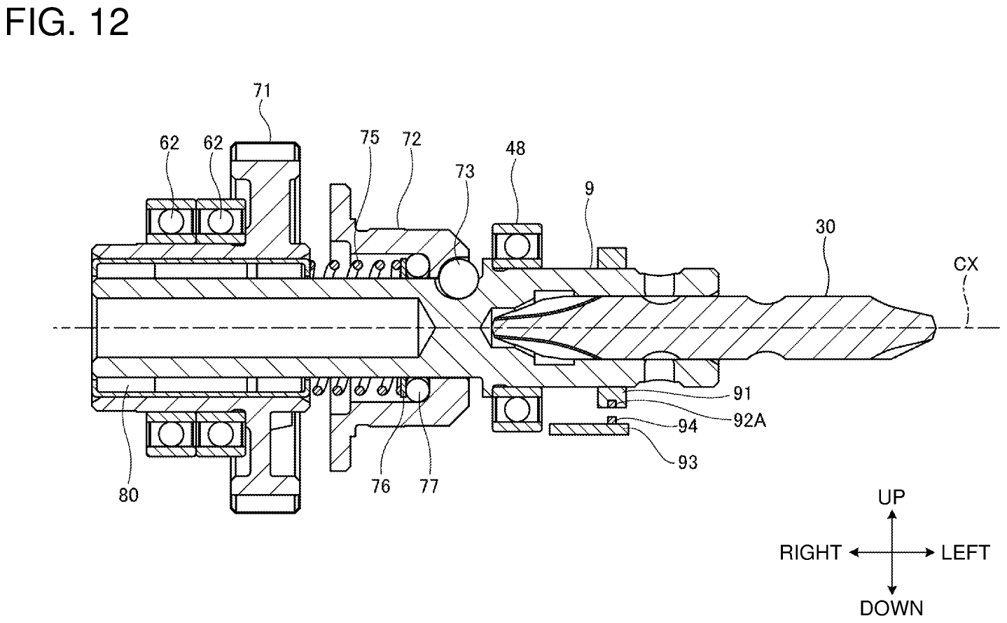

FIG. 12 is a longitudinal sectional view of a main part of a screwdriver according to a modification. As shown in FIG. 12, the mode sensor board 93 including the magnetic sensor 94 may be located frontward from the spindle front bearings 48. A magnet 92A may be located frontward from the spindle front bearings 48.

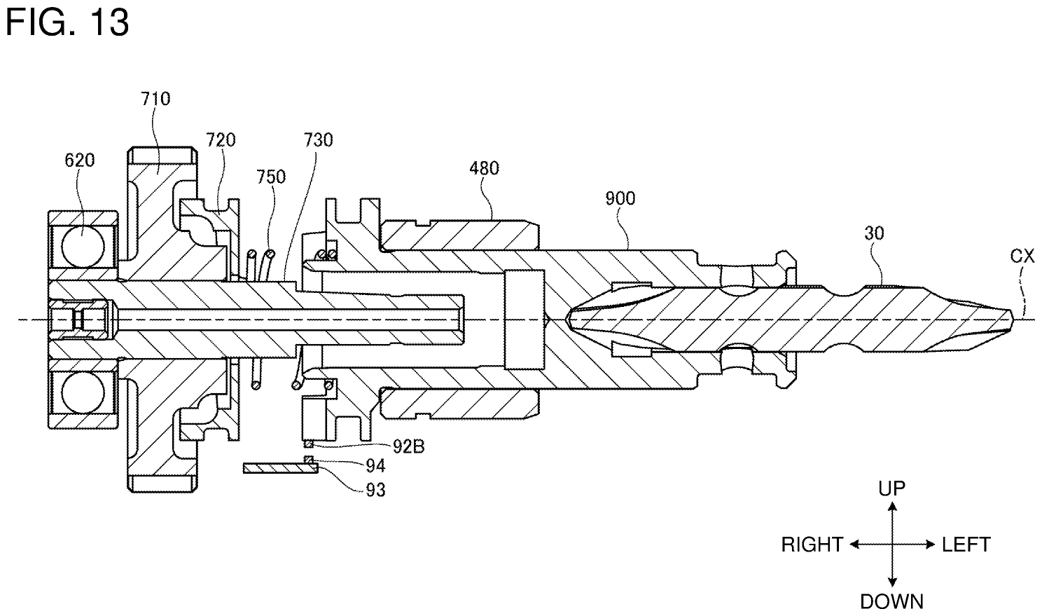

FIG. 13 is a longitudinal sectional view a main part of a screwdriver according to a modification. In the embodiment described above, the spindle 9 includes the support shaft. As shown in FIG. 13, a drive gear 710 may be supported on a support shaft 730 different from a spindle 900. The spindle 900 is at least partially located frontward from the support shaft 730. The clutch cam 720 may be connected to the drive gear 710. The support shaft 730 has its rear end rotatably supported by a bearing 620. The spindle 900 is rotatably supported by a spindle bearing 480. A compression spring 750 urges the spindle 900 forward. The mode sensor board 93 including the magnetic sensor 94 may be located frontward from the bearing 620. The mode sensor board 93 including the magnetic sensor 94 may be located frontward from the drive gear 710. In the example shown in FIG. 13, the mode sensor board 93 including the magnetic sensor 94 is located radially outward from the support shaft 730. A magnet 92B surrounds the rear end of the spindle 900. The magnetic sensor 94 detects the magnet 92B. The magnetic sensor 94 and at least a part of the support shaft 730 are aligned with each other in the front-rear direction. The magnet 92B and at least a part of the support shaft 730 may be aligned with each other in the front-rear direction.

In the embodiment described above, the spindle 9 and the magnet 92 move together in the front-rear direction. In some embodiments, for example, the magnet 92 may start moving after the spindle 9 starts moving. The spindle 9 and the magnet 92 may move by the same distance or different distances. When the spindle 9 moves backward, the magnet 92 may move forward. The magnet 92 may move in synchronization with the spindle 9.

In the embodiment described above, the push-in sensor to detect the clutch cam 72 (push-in clutch) being pushed in is the magnetic sensor 94 (Hall element) that detects the magnet (e.g., magnet 92). The push-in sensor may be any sensor that can detect the clutch cam 72 being pushed in, in place of the magnetic sensor 94. Any noncontact sensor may be used as a push-in sensor. The push-in sensor may also be a contact switch. For example, a switch such as a tact switch may be pushed into the clutch cam 72 to detect the clutch cam 72 being pushed in.

In the above embodiment, the screwdriver 1 may use utility power (alternating current power supply) in place of the battery pack 25.

### REFERENCE SIGNS LIST

1 screwdriver
2 main housing
2A recess
2L left housing
2R right housing
2S screw
3 gear housing
3S screw
4 cover
4A first cover unit
4B second cover unit
4C third cover unit
4D fourth cover unit
5 battery mount
6 motor
7 fan
8 power transmission
8A clutch assembly
8B spindle locking assembly
9 spindle
9A rod
9B stopper
9C bit holding hole
9D hollow portion
9E spindle ball groove
9F through-hole
10 tool holder
11 lock ring
12 adjusting sleeve
13 rubber cap
14 trigger lever
15 lock button
16 forward-reverse switch lever
17 light
18 switch plate
18A mode switch button
19 bit position detector
20 controller
20A circuit board
20B case
21 motor compartment
21A recess
22 handle
22A grip
22B joint
23 battery holder
24 joint
25 battery pack
26 inlet
27 outlet
29 sleeve
30 screwdriver bit
30A recess
31 rear housing
31A plate
31B recess
31C cylinder
31D receiving recess
32 front housing
32A plate
32B cylindrical portion
32G recess
33 stator
34 rotor
35 stator core
36F front insulator
36R rear insulator
37 coil
38 short-circuiting member
39 connector
39S screw
40 rotor core
41 rotor shaft
42 rotor magnet
43 rotation sensor board
43S screw
44 rotor bearing
45 rotor bearing
46 circlip
47 pinion gear
48 spindle front bearing
49 ball
50 ring
51 spring
52 O-ring
54 switch
62 spindle rear bearing (first bearing)
63 oil seal
71 drive gear
71A ring
71B gear
71C cylindrical portion
71D drive cam
72 clutch cam
72A support ring
72B cylindrical portion
72C cam ring
72D cam ball groove
72E follower cam
73 ball
75 compression spring
76 washer
77 ball
80 one-way needle bearing
90 bearing (second bearing)
91 movable member
91A ring
91B protrusion
92 magnet
92A magnet
92B magnet
93 mode sensor board
94 magnetic sensor
95 resin layer
96 lead wire
480 spindle bearing
620 bearing
710 drive gear
720 clutch cam
730 support shaft
750 compression spring
900 spindle
AX rotation axis
CX rotation axis (first rotation axis)

What is claimed is:

1. A screwdriver, comprising:
a motor;
a push-in clutch located frontward from the motor, the push-in clutch being drivable by the motor;
a spindle located frontward from the push-in clutch, the spindle being drivable by the push-in clutch;
a push-in sensor located radially outward from and below the push-in clutch, the push-in sensor being configured to detect the push-in clutch being pushed in; and
a battery configured to power the motor.

2. The screwdriver according to claim 1, further comprising:
a pinion gear rotatable by the motor;
a drive gear meshing with the pinion gear and rotatable about a first rotation axis;
a first bearing located rearward from the drive gear, the first bearing supporting the support shaft in a rotatable manner; and
a magnet located frontward from the first bearing and the drive gear, the magnet being movable in the front-rear direction in synchronization with the spindle.

3. The screwdriver according to claim 2, wherein
the magnet and at least a part of the spindle are aligned with each other in the front-rear direction.

4. The screwdriver according to claim 2, further comprising:
a movable member surrounding the spindle, the movable member being movable in the front-rear direction together with the spindle,
wherein the magnet is fixed to the movable member.

5. The screwdriver according to claim 4, further comprising:
a second bearing between the spindle and the movable member; and
a rotation locking assembly configured to restrict rotation of the movable member relative to the housing.

6. The screwdriver according to claim 5, further comprising:
a clutch cam surrounding the spindle and connected to the spindle with a ball in between, the clutch cam including the follower cam,
wherein the movable member surrounds the clutch cam, and
the second bearing is between the clutch cam and the movable member.

7. The screwdriver according to claim 4, further comprising:
a guide configured to guide the movable member in the front-rear direction.

8. The screwdriver according to claim 1, wherein
the spindle includes the support shaft.

9. The screwdriver according to claim 2, further comprising:
a drive cam included in the drive gear, the drive cam rotatable about the first rotation axis by the drive gear.

10. A screwdriver, comprising:
a motor;
a push-in clutch located frontward from the motor, the push-in clutch being drivable by the motor;
a spindle located frontward from the push-in clutch, the spindle being drivable by the push-in clutch;
a push-in sensor located radially outward from the push-in clutch, the push-in sensor being configured to detect the push-in clutch being pushed in;
a battery configured to power the motor;
a second bearing supporting the push-in clutch in a rotatable manner; and
a magnet supporting the second bearing in a rotatable manner.

11. A screwdriver, comprising:
a motor;
a push-in clutch located frontward from the motor, the push-in clutch being drivable by the motor;
a spindle located frontward from the push-in clutch, the spindle being drivable by the push-in clutch;
a magnet located radially outward from the push-in clutch, the magnet being movable in the front-rear direction in synchronization with the spindle;
a magnetic sensor located radially outward from the spindle, the magnetic sensor being configured to detect the magnet;
a battery configured to power the motor;
a spindle front bearing supporting the spindle in a rotatable manner; and
a front housing supporting the spindle front bearing, the front housing located between the magnet and the magnetic sensor.

12. The screwdriver according to claim 3, further comprising:
a movable member surrounding the spindle, the movable member being movable in the front-rear direction together with the spindle,
wherein the magnet is fixed to the movable member.

13. The screwdriver according to claim 5, further comprising:
a guide configured to guide the movable member in the front-rear direction.

14. The screwdriver according to claim 6, further comprising:
a guide configured to guide the movable member in the front-rear direction.

15. The screwdriver according to claim 2, wherein
the spindle includes the support shaft.

16. The screwdriver according to claim 3, wherein
the spindle includes the support shaft.

17. The screwdriver according to claim 4, wherein
the spindle includes the support shaft.

18. The screwdriver according to claim 5, wherein
the spindle includes the support shaft.

19. The screwdriver according to claim 6, wherein
the spindle includes the support shaft.

20. The screwdriver according to claim 7, wherein
the spindle includes the support shaft.
